(19) United States
(12) Patent Application Publication
(10) Pub. No.: US 2010/0162158 A1
(43) Pub. Date: Jun. 24, 2010

(54) METHOD PROVIDING A PLURALITY OF SELECTABLE VALUES SUITABLE FOR AN INPUT OF A TEXT FIELD

(76) Inventors: Kerstin Dittmar, Stuttgart (DE); Nadine Beigel, Schwetzingen (DE); Ingo Deck, Mannheim (DE); Annett Hardt, Mannheim (DE); Theo Held, Wiesloch (DE); Dietrich Mayer-Ullmann, Ilvesheim (DE); Martin Schrepp, Hockenheim (DE)

Correspondence Address: SAP AG, 3410 HILLVIEW AVENUE, PALO ALTO, CA, 94304, US

(21) Appl. No.: 12/337,759

(22) Filed: Dec. 18, 2008

(51) Int. Cl. G06F 3/048; G06F 17/30

(52) U.S. Cl. 715/780; 707/E17.014

(57) ABSTRACT

Described herein is a method, providing a user of a graphical user interface (GUI) with a plurality of selectable values, suitable for an input of a text field in the GUI. Each time the user enters a character in the text field, a background search is performed and the plurality of selectable values is reduced to the matching values only. In case the selectable values consist of multiple words, the background search matches the input to each of the consisting words. If the user does not enter a character in the text field, the method displays a plurality of selectable values when the user performs a double-click over the text field or uses backspace key while the text field is selected. If there is no user context defined, the displayed plurality of selectable values consists of a predefined number of last recently used values in the text field. If the user is working in a context, the displayed plurality of selectable values consists of a predefined number of previously entered context specific values.

### FIELD OF THE INVENTION

The field of invention relates generally to software, and particularly but not exclusively, relates to displaying a plurality of selectable values suggested as a possible input for a text field in a user interface.

### BACKGROUND OF THE INVENTION

A user interface is a typical component of the modern software solutions. Most user interfaces comprise text fields to receive a text input from the user. Usually, the text input is typed in via keyboard, but some software solutions suggest a plurality of selectable values as a possible input for the specific text field. The plurality of selectable values is often offered by the user interface in a pop-up window after a specific user request. The suggested values might represent a fixed amount of values in a predefined range, i.e., dates in a calendar, or might be derived from the values previously entered in the text fields of the user interface. Either way, the amount of selectable values suggested by the user interface is often too large and the user is forced to search an appropriate value. The process is time consuming and does not guarantee that the user will find the appropriate value.

A viable improvement of the value suggesting process would be providing only the last recently used values or only the previously entered values in a specific context. This way, the plurality of suggested values will be reduced to a significantly smaller amount, which will speed up the search process. Also, the chance an appropriate value to be found will be increased, due to the fact that all suggested values will be derived from previously entered values in text fields having the same label. An intelligent background search may also be provided in order to further narrow the plurality of suggested values every time the user types in a character in the text field.

### SUMMARY OF THE INVENTION

Described herein is a method, providing a user of a graphical user interface (GUI) with a plurality of selectable values, suitable for an input of a text field in the GUI. Each time the user enters a character in the text field, a background search is performed and the plurality of selectable values is reduced to the matching values only. In case the selectable values consist of multiple words, the background search matches the input to each of the consisting words. If the user does not enter a character in the text field, the method displays a plurality of selectable values when the user performs a double-click over the text field or uses backspace key while the text field is selected. If there is no context defined, the displayed plurality of selectable values consists of a predefined number of last recently used values in the text field. If the user is working in a context, the displayed plurality of selectable values consists of a predefined number of previously entered context specific values.

### BRIEF DESCRIPTION OF THE DRAWINGS

A better understanding of the present invention can be obtained from the following detailed description in conjunction with the following drawings, in which:

FIG. 1 is a flow diagram of a process displaying a plurality of selectable values, suitable for an input of a text field in a graphical user interface, in accordance with an embodiment of the present invention.

FIG. 2 is a flow diagram of a process displaying results of background search for matching selectable values, in accordance with an embodiment of the present invention.

FIG. 3A is an example of a text field rendered on a graphical user interface (GUI), displaying a plurality of selectable values comprising a predefined number of last recently used values in the text field, displayed if a user does not enter a character in the text field, in accordance with an embodiment of the present invention.

FIG. 3B is an example of a text field rendered on a GUI, displaying a plurality of selectable values comprising results of a background search, in accordance with an embodiment of the present invention.

FIG. 3C is an example of a text field rendered on a GUI, displaying a plurality of selectable values consisting of multiple words, in accordance with an embodiment of the present invention.

### DETAILED DESCRIPTION

Embodiments of a method and machine readable medium displaying a plurality of selectable values, suitable for an input of a text field in a user interface are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “this embodiment” means that a particular feature, structure, or characteristic described in connection with the embodiment is included in at least one embodiment of the present invention. Thus, the appearances of the phrases “in one embodiment” or “in this embodiment” in various places throughout this specification are not necessarily all referring to the same embodiment. Furthermore, the particular features, structures, or characteristics may be combined in any suitable manner in one or more embodiments.

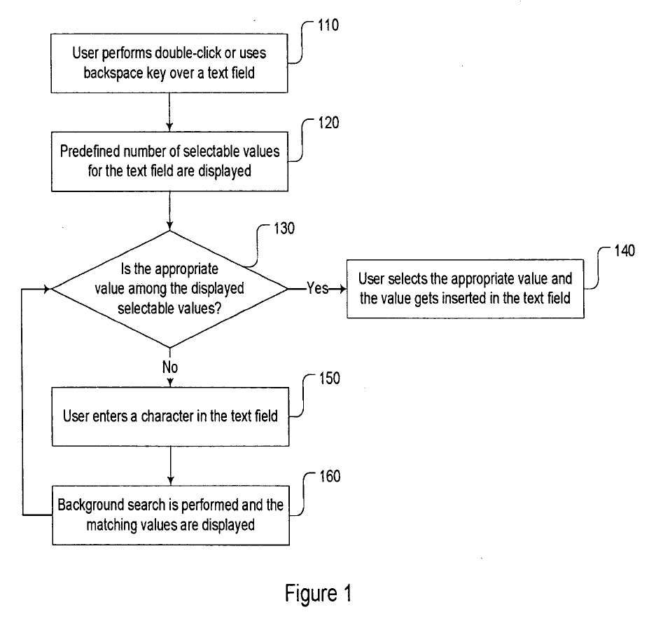

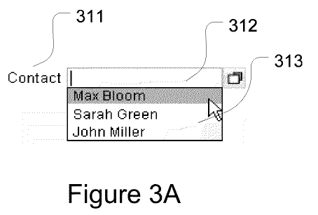

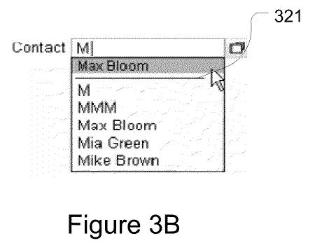

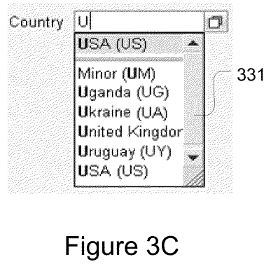

FIG. 1 is a flow diagram of a process displaying a plurality of selectable values, suitable for an input of a text field in a user interface. The process starts when the user selects the text field and performs double-click or uses a backspace key at block 110. At block 120, a list of selectable values is displayed beneath the text field. If there is no context defined, the list consists of a predefined number of last recently used values in this field, in chronological order. A last recently used value is a previously entered value in the text field during the last usage of the GUI. For example, if the user enters in the text field the value John Miller, followed by the value Sarah Green and finally Max Bloom, when he selects the field again and performs a double-click or uses a backspace key, the list of selectable values displayed beneath the text field will comprise these values in the following order: Max Bloom, followed by Sarah Green, and finally John Miller, as shown on FIG. 3A. If the user is working in a context, the displayed plurality of selectable values consists of a predefined number of previously entered context specific values. At block 130, the user tries to find the value that he wants to enter in the text field (referred to as the appropriate value throughout this document), among the values displayed beneath the text field at block 120 (referred to as selectable values throughout this document). If the appropriate value is among the selectable values, the user selects the value from the list and the value gets inserted in the text field at block 140. If not, the user starts entering the appropriate value by typing in its first character in the text field at block 150. At block 160, a background search is performed in order to find all values, matching to the input received at block 150. The list of selectable values is populated with the matching values, displayed in alphabetical order. If the user is still unable to find the appropriate value, the steps at blocks 150 and 160 are repeated until the list of selectable values is narrowed down to the appropriate value and the user selects it, or until there are no more matching previously entered values to display.

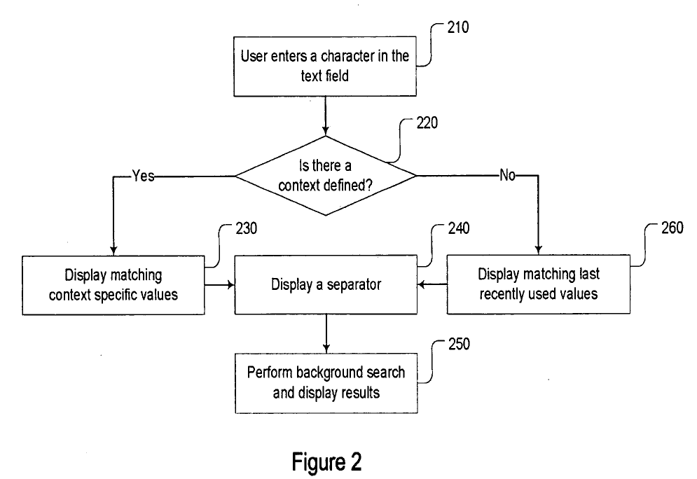

FIG. 2 is a flow diagram of a process displaying results of background search for matching selectable values. In one embodiment, all logically connected graphical user interface (GUI) work areas, having identically labeled text fields, define a context. Contexts can be fixed by the user or dynamically defined by the GUI in accordance with the operations performed by the user. As long as the user navigates within logically connected work areas, the context gets updated with the values entered in the text fields by the user. The context will be reset when the user navigates out of the logically connected work areas or if the user explicitly deletes it.

At block 210, the user starts entering the appropriate value in the text field by typing in a character. At block 220, a check is performed if the user is working in a previously defined context. If there is a defined context, at block 230 a predefined number of context specific values are displayed, matching the input received at block 210. The appropriate value will most likely be present in the current context and displaying the matching values from the same context will reduce significantly the amount of selectable values proposed to the user. If there is no context defined, at block 260 a predefined number of matching the input last recently used values are displayed. At block 240, a separator is displayed at the end of the list of selectable values, displayed at block 230 or block 260. At block 250, a background search is performed in order to find all matching to the input received at block 210 values, used in fields with the same label. The result is displayed after the separator, displayed at block 240. If there is a context defined when the check at block 220 is performed, the background search at block 250 is performed only outside the context. Having the matching values outside the context provides the user an alternative list of selectable values to choose from, in case the appropriate value has not been used in the current context yet.

FIG. 3A is an example of a text field rendered on a graphical user interface (GUI), displaying a plurality of selectable values comprising a predefined number of last recently used values in the text field, displayed if a user does not enter a character in the text field. The text field comprises a label (311), which serves as a text field identifier in the GUI, a text entry area (312) to receive a text input from the user, and a drop down text area (313) to display a plurality of previously entered values in the text entry areas of the text fields having the same label. As described in reference to FIG. 1 above, when the user selects the text field in the GUI and performs double-click or uses a backspace key, a list of selectable values is displayed at block 120, comprising a predefined number of last recently used values in this field. The last recently used values are displayed in chronological order. The predefined number of last recently used values to be displayed is a configurable option of the user interface. It this embodiment, the predefined number of last recently used values displayed is set to three. If the appropriate value is among the selectable values, the user selects the value from the list and the value gets inserted in the text field.

FIG. 3B is an example of a text field rendered on a GUI, displaying a plurality of selectable values comprising results of a background search. If the appropriate value is not among the selectable values, shown on FIG. 3A, the user starts entering the appropriate value by typing in its first character in the text field at block 210, as described in reference to FIG. 2 above. As a result from entering the character M in the field, the list of selectable values from FIG. 3A is narrowed down to the only value that matches the input, Max Bloom. The background search, performed at block 250, finds five more matching values, previously used in fields labeled Contact. They are displayed in the drop down text area (313) after the separator (321) as described in reference to FIG. 2 above.

FIG. 3C is an example of a text field rendered on a GUI, displaying a plurality of selectable values consisting of multiple words. The background search attempts to match the input, provided in the text field, to each word of the previously entered values. If the input matches to any of the multiple words, the value is added to the result. For example, only the second word of the value Minor (UM) matches the input U, but the value is included in the search result. The drop down text area (313) comprises a predefined number of selectable rows to be populated with previously entered values. The predefined number of selectable rows is a configurable option of the GUI. If the actual count of the matching values exceeds that number, a scroll bar (331) for navigation within the drop down text area (313) is displayed to ensure accessibility of all matching values.

The above description of illustrated embodiments of the invention, including what is described in the Abstract, is not intended to be exhaustive or to limit the invention to the precise forms disclosed. While specific embodiments of, and examples for the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A computerized method, providing a user of a graphical user interface (GUI) with a plurality of selectable values, suitable for an input of a text field, comprising:
receiving input in a text field;
identifying a context;
if no input is received and no context is identified, displaying a plurality of last recently used values;
if no input is received and a context is identified, displaying a plurality of previously entered context specific values;
if an input is received and no context is identified, displaying a matching to the input plurality of last recently used values and a matching to the input plurality of previously entered non-context specific values; and
if an input is received and a context is identified, displaying a matching to the input plurality of previously entered context specific values and the matching to the input plurality of previously entered non-context specific values.

2. The method of claim 1, wherein displaying a matching to the input plurality of previously entered non-context specific values comprises:
performing a background search for the matching to the input plurality of previously entered non-context specific values;
displaying a separator; and
displaying a background search result.

3. The method of claim 2, wherein performing a background search comprises:
if a previously entered value consists of multiple words,
matching each of the multiple words to the input, and
adding the previously entered value to the background search result, when
at least one of its multiple words matches the input.

4. The method of claim 1 further comprising displaying of matching to the input previously entered values in alphabetical order.

5. The method of claim 1 further comprising displaying a plurality of previously entered values after receiving notification of a double-click event over the text field.

6. The method of claim 1 further comprising displaying a plurality of previously entered values after receiving notification of a backspace key event while the text field is selected.

7. The method of claim 1 further comprising displaying the plurality of last recently used values in chronological order.

8. The method of claim 1 further comprising displaying a predefined number of previously entered values.

9. A machine readable medium having a set of instructions stored therein which when executed cause a machine to perform a set of operations, providing a user of a GUI with a plurality of selectable values, suitable for an input of a text field, comprising:
receiving input in a text field;
identifying a context;
if no input is received and no context is identified, displaying a plurality of last recently used values;
if no input is received and a context is identified, displaying a plurality of previously entered context specific values;
if an input is received and no context is identified, displaying a matching to the input plurality of last recently used values and a matching to the input plurality of previously entered non-context specific values; and
if an input is received and a context is identified, displaying a matching to the input plurality of previously entered context specific values and the matching to the input plurality of previously entered non-context specific values.

10. The machine readable medium of claim 9, wherein displaying a matching to the input plurality of previously entered non-context specific values comprises:
performing a background search for the matching to the input plurality of previously entered non-context specific values;
displaying a separator; and
displaying a background search result.

11. The machine readable medium of claim 10, wherein performing a background search comprises:
if a previously entered value consists of multiple words,
matching each of the multiple words to the input, and
adding the previously entered value to the background search result,
wherein at least one of its multiple words matches the input.

12. The machine readable medium of claim 9 further comprising displaying of matching to the input previously entered values in alphabetical order.

13. The machine readable medium of claim 9 further comprising displaying a plurality of previously entered values after receiving notification of a double-click event over the text field.

14. The machine readable medium of claim 9 further comprising displaying a plurality of previously entered values after receiving notification of a backspace key event while the text field is selected.

15. The machine readable medium of claim 9 further comprising displaying the plurality of last recently used values in chronological order.

16. The machine readable medium of claim 9 further comprising displaying a predefined number of previously entered values.

17. A graphical user interface (GUI) comprising:
a text input field rendered on the GUI;
a label to identify the text input field on the GUI;
a text entry area rendered on the GUI to receive a text input; and
a drop down text area rendered on the GUI to display a plurality of previously entered values in the text entry areas of the text fields having the same label.

18. The GUI of claim 17, wherein the drop down text area comprises:
a predefined number of selectable rows to be populated with previously entered values; and
if the number of previously entered values is greater than the predefined number of selectable rows, a side scroll bar for navigation within the drop down text area.

19. The GUI of claim 18, wherein selecting a value populating a selectable row causes the selected value to be displayed in the text entry area.

20. The GUI of claim 17, wherein the drop down text area further comprises a separator to visually separate the displayed plurality of previously entered values.
